(19) United States
(12) Patent Application Publication
(10) Pub. No.: US 2021/0370285 A1
(43) Pub. Date: Dec. 2, 2021

(54) Apparatus and method for collecting multi-tiered particles from a biological sample

(71) Applicants: Keith Wetherby, ELLICOTT CITY, MD (US); Xinjing Wang, WASHINGTON, DC (US); Maria Apostolopoulou, WASHINGTON, DC (US)

(72) Inventors: Keith Wetherby, ELLICOTT CITY, MD (US); Xinjing Wang, WASHINGTON, DC (US); Maria Apostolopoulou, WASHINGTON, DC (US)

(21) Appl. No.: 16/889,676

(22) Filed: Jun. 1, 2020

(51) Int. Cl. B01L 3/00

(52) U.S. Cl. CPC B01L 3/502; B01L 2300/0861; B01L 2300/0681; B01L 2200/0652

(57) ABSTRACT

An apparatus and method for collecting multi-tiered particles from various biological samples for use in downstream biological procedures. Two filters compatible with the device, and of different pore size, are connected via a conduit or are integrated into the conduit. A biological sample is driven through the conduit by applying pressure to one of the inlet ports. The flow of the biological sample is directed to the desired output port by positioning of the internal switch. A switch directs the fluid to flow within the device to elute trapped particles captured on the filters. The apparatus allows for the collection of unstimulated, intact particles without the need for multiple redraws of sample or filtrate. Collection and analysis of biological samples are valuable for correct diagnosis and therapy of a wide variety of different conditions.

### BACKGROUND OF THE INVENTION

The present invention relates to filtering various biological samples, particularly for the use in downstream biological procedures. In particular, the present invention relates to using a handheld apparatus to filter biological fluid and to collect the resulting filtrate(s) containing intact particles, without using stimulation or interaction, for use in applications such as but not limited to PCR, RT-PCR, NGS, and protein analysis. Particles include, but are not limited to, extracellular vesicles, oncosomes, exosomes, microvesicles and/or virons.

Full utilization of precious biological samples is desirable and taking advantage of sensitive diagnostic equipment allows for smaller volumes of biological sample to be collected. It is advantageous to separate biological samples via size filtration into separate components because the specific size collection filtrate may provide a better idea of the source of the particles. The particles collected in various size ranges can be used in identifying and treating a wide variety of conditions, including some types of cancer, neurological disorders and/or infectious disease.

The capabilities of next generation sequencers, single molecule sequencers, and quantitative PCR readers have low input requirements to run diagnostic procedures. The higher sensitivity of these laboratory equipment allows researchers to use minimal biological sample for testing. Full utilization of precious biological samples is necessary to minimize invasive procedures for the patient.

Clinicians may request sample collection at various points before, during and after treatment to monitor patient progress. The present invention is designed to collect various sized particles within a single use device. The device is compatible with various biological fluids and the method is designed to be used to separate extracellular vesicles from other components of a biological sample.

Representative systems are disclosed, for example, in U.S. Published Patent Application No. U.S. Pat. No. 7,176,034 B2 filed on Feb. 13, 2007, which is incorporated herein by reference in their entireties. Such apparatus has biological sample filtering capability; for filtering/collecting mucoid and/or suspension samples. The invention relates to a two-vial interconnected filtration system, that allows samples to unidirectionally pass from a sample tube to a filtrate tube, through standardized filters and to be treated with standardized reagents for analysis.

The filtration of biological samples within current available apparatus are limited to unidirectional flow, capturing only specified particles, and/or the inability to change filter types or sizes. The specialized capability of current systems requires added volumes of precious biological sample to be used for any additional testing. For instance, if a sample is filtered for a specified molecule, additional important biomarkers are collected as waste and potentially thrown out or not tested. Filtration and collection of biological samples requires full utilization of biological sample to reduce the amount of sample needed from the patient and to reduce the volume of sample drawn from patient. The present invention can utilize the entire biological sample by separating components for various testing procedures based on size exclusion.

### BRIEF SUMMARY OF THE INVENTION

The present invention is directed to an apparatus that can utilize entire biological samples by separating particles, including extracellular vesicles, into multi-tiered filtrates without the need for multiple re-draws of sample or filtrate.

The apparatus consists of these principal components;
a primary filter, typically equal to or larger than 0.22 microns, to trap and collect particles equal to or larger than the filter pore size used;
a secondary filter, typically a smaller pore size than the primary filter, typically smaller than 0.22 microns, to trap particles equal to or larger than the filter pore size used;
a main conduit, containing the primary and secondary filters, a switch and a collection chamber extending perpendicular to the main chamber, that allows the biological samples to transition from inlet port to desired outlet port via switch position;
an inlet/outlet port to collect small particles, or particles smaller in size than the secondary filter pore size, e.g. less than 0.05 microns, from the biological sample, also used as an elution port to elute intermediate particles;
an inlet/outlet port on the collection chamber to allow intermediate size filtrate, or particles ranging in size from the primary filter pore size to the secondary filter pore size, e.g. 0.22 microns to 0.05 microns, to be collected, or to attach additional devices to the apparatus such as extended tubing, pumps, peltier device, ultrasonication, acoustic vibration, or microfluidic devices, also used as an inlet port to elute large particles;
an inlet/outlet port to collect large size range particles, or particles larger in size than the primary filter pore size, e.g. greater than 0.22 microns, from the biological sample, also used as an injection port to process the biological sample.

In one aspect of the invention, the filters are of fixed size and integrated into the conduit. In some embodiments, the device is customizable with off the shelf syringe filters, e.g., Millex® (Merck Millipore, Cork, Ireland). In another embodiment, there is some combination of fixed and customized filter sizes and filter types.

In one embodiment, the primary filter type is PES. In another it is PVDF. Or any other suitable material. In one embodiment, the primary casing size is 33 mm. In another it is 13 mm, or integrated into the conduit, or any other size. In one embodiment, the primary membrane size is 0.22 microns. In another it is 0.45 microns, 1 micron or any other size.

In one embodiment, the secondary filter type is PES. In another it is PVDF. Or any other suitable material. In one embodiment, the secondary filter casing size is 33 mm. In another it is 13 mm, or integrated into the conduit, or any other size. In one embodiment, the secondary filter membrane size is 0.03 microns. In another it is 0.05 microns, 0.045 microns or any other size.

The present invention features methods of separating a biological sample into multiple tiered filtrate components. In some embodiments, the biological sample comprises biological fluid, e.g. human biological fluid. In one embodiment, the sample comprises urine, mucus, saliva, tears, blood, serum, plasma, sputum, cerebrospinal fluid, ascites fluid, semen, lymph fluid, airway fluid, intestinal fluid, breast milk, amniotic fluid or any combination thereof.

In one embodiment, the wash solution consists of 1×PBS pH 7.4. In another embodiment the wash solution consists of 1×PBS pH 7.5 with 0.05% polysorbate 20, or molecular grade water, or Tris-EDTA pH 8.0, or TE pH 7.4 or some combination of two or all.

In one embodiment, the eluting solution consists of 1×PBS pH 7.4. In another embodiment the eluting solution consists of 1×PBS pH 7:5 with 0.05% polysorbate 20, or molecular grade water, or Tris-EDTA pH 8.0, or TE pH 7.4 or some combination of two or all.

The flow of biological fluid is controlled by either an electrically or manually driven piston. Pressure applied to either of the main chamber inlet ports or the collection chamber inlet port, with the switch in position 1, 2, or 3, determines the direction of fluid flow. When fluid is dispensed into the primary filter with the switch in position 1, it enters the main chamber and exits the secondary filter outlet port. When fluid is dispensed into the secondary filter with the switch in the position 2, it enters the main chamber and is re-directed into the collection chamber outlet port. When fluid is dispensed into the collection chamber inlet port with the switch in position 3, it enters the main chamber and is re-directed to the primary filter outlet port.

In one embodiment, the piston is part of an electrical pump. In another embodiment, the piston is manually driven and is part of a syringe or some other device.

Filtrates, once collected, can be used for downstream applications such as PCR, RT-PCR, NGS and protein analysis. Nucleic acids are protected from degradation inside vesicle lipid bilayers so filtrates can be stored several months at −80° C. without effecting downstream results. Extracellular vesicle lipid bilayers are disrupted using high heat to facilitate the release of nucleic acids and other cargo. For example, a 25 μL aliquot of the filtrate can be heated at 95° C. for 10 min to release RNA. A one step RT-PCR kit (Bioline, Cat #78001) is then used to create cDNA using either random hexamer primers, polyT primers or gene specific primers or some combination. The PCR amplification step is carried out in the same well where an amplicon specific fluorescent probe allows the target to be quantified through an amplification dependent increase in fluorescence. The use of different fluorescent dyes permits multiple targets to be analyzed in a single reaction.

Nucleic acid released from vesicles can be modified for use in various sequencing applications. Adaptors and priming sites can be added to cDNA and DNA for sequencing via Illumina sequencers, such as the Illumina miniSeq or Oxford Nanopore Technologies Minlon.

### BRIEF DESCRIPTION OF THE DRAWINGS

FIG. 1 is an illustration of the sample collection device.

FIG. 2 is an illustration of the sample collection device partially exploded with off the shelf filters.

FIG. 3 is an illustration of the sample collection device assembled with off the shelf filters.

FIGS. 4-6 are illustrations demonstrating switch position and fluid flow. Switch position 1 (FIG. 4) permits fluid flow from the primary filter port to the secondary filter port. Switch position 2 (FIG. 5) permits fluid flow from the secondary filter port to the collection chamber port. Switch position 3 (FIG. 6) permits fluid flow from the collection chamber port to the primary filter port.

FIGS. 7-9 are subsequent illustrations of switch position 1 fluid flow of the biological sample, shown by the red arrow, where intermediate particles are represented as red circles, small particles as blue squares and large particles as green triangles, entering the inlet port of the primary filter (FIG. 7). Large particles are trapped on the primary filter while the biological sample continues through the main chamber of the conduit with the internal switch in the position 1, which prevents flow from entering the collection chamber (FIG. 8). Small size particles are collected from the secondary filter outlet port and intermediate particles are prevented from exiting the device by the secondary filter (FIG. 9).

FIGS. 10-12 are subsequent illustrations of the switch position 2 fluid flow of the biological sample, shown by the red arrow, commencing at the secondary filter inlet port (FIG. 10). Intermediate particles enter the collection chamber from the main chamber with the internal switch in position 2, which prevents flow from entering the primary filter in the main chamber (FIG. 11). The intermediate particles are collected from the collection chamber outlet port (FIG. 12).

FIGS. 13-14 are subsequent illustrations of the switch position 3 fluid flow of the biological sample, shown by the red arrow, commencing at the collection chamber inlet port (FIG. 13). Fluid enters the collection chamber and the main chamber with the internal switch in position 2, preventing flow from entering the secondary filter in the main chamber. Large particles are collected from the primary filter outlet port (FIG. 14).

FIG. 15 is an illustration of the multi-tiered collection of various sized particles represented by green triangles (large particles), red circles (intermediate sized particles), and blue squares (small sized particles).

FIGS. 16-20 are qPCR data of reference gene β-actin (FIG. 15-18) and KRAS (FIG. 19) using eluants from various sized filters assembled with the apparatus and methods described herein. Filtration and collection of a biological sample using tiered filters of size 1 μm, 0.45 μm, 0.22 μm and 0.05 μm were used to amplify ACTB from the resulting filtrates in FIGS. 15 through 18 respectively. A known homozygous KRAS G12S mutation (FIG. 19) amplified from RNA using the apparatus and methods described herein.

FIG. 21 Exosomes can be stained for exosomal markers after isolation. A) Exosomes bound on latex beads stained for CD9 (green, middle panel) and TAPA-1 (red, right panel). In addition, this method of exosome isolation lead to the capture on beads of exosomes CD9+TAPA1+ (yellow arrow), CD9+TAPA1− (green arrow) and CD9−TAPA1+ (red arrow). B) Exosomes bound on latex beads stained for CD63 (green, middle panel) and TAPA-1 (red, right panel). Again, exosomes captured were CD63+TAPA1+ (yellow arrow), CD63+TAPA1− (green arrow) or CD63−TAPA1+(red arrow). Right panels are composite images with a DIC image of the beads. In contrast, no fluorescence was observed after staining beads with the antibodies mentioned above in the absence of exosomes (C, D), and no auto-fluorescence was observed from bead-bound exosomes in the absence of the antibodies (E).

FIG. 21-25. qPCR output from EV nucleic acids procured using our pre-PCR treatment is as good, if not better, than existing commercially available protocols. Conditioned media was collected from 4 cell lines (MCF7, OE19, SNU-16 and SK-BR-3) and EVs were isolated using our kit. Samples were then split into two aliquots. RNA was isolated from one aliquot using Direct-zol™ RNA Mini-Prep (zymo) following the manufacturer's instructions. The other aliquot was heated at 95° C. for 10 min (Akrigene). Relative amounts of both isolated RNA and heated samples were used for qPCR amplification of β-actin. In all cell lines, the heating protocol released nucleic acids of similar, or slightly better, quality for downstream qPCR applications. Graphs show mean+−SEM; * indicates statistically significant differences (p<0.05, n=3, paired t-test).

### DETAILED DESCRIPTION OF THE INVENTION

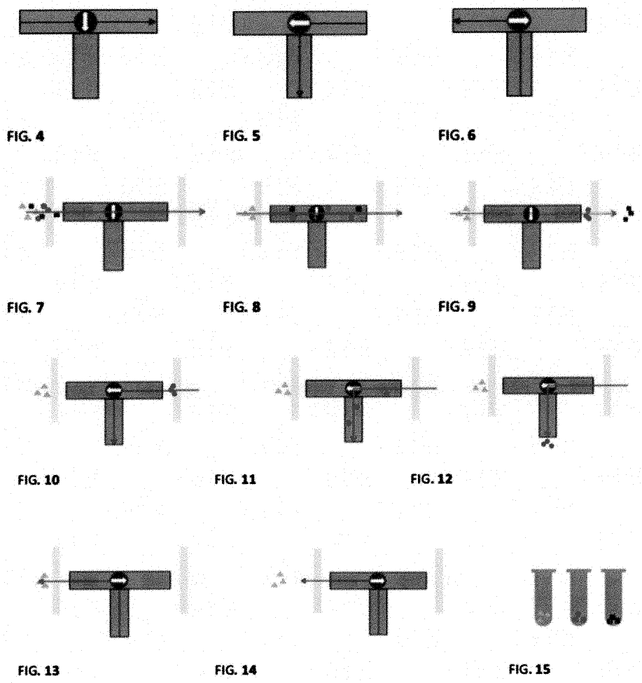

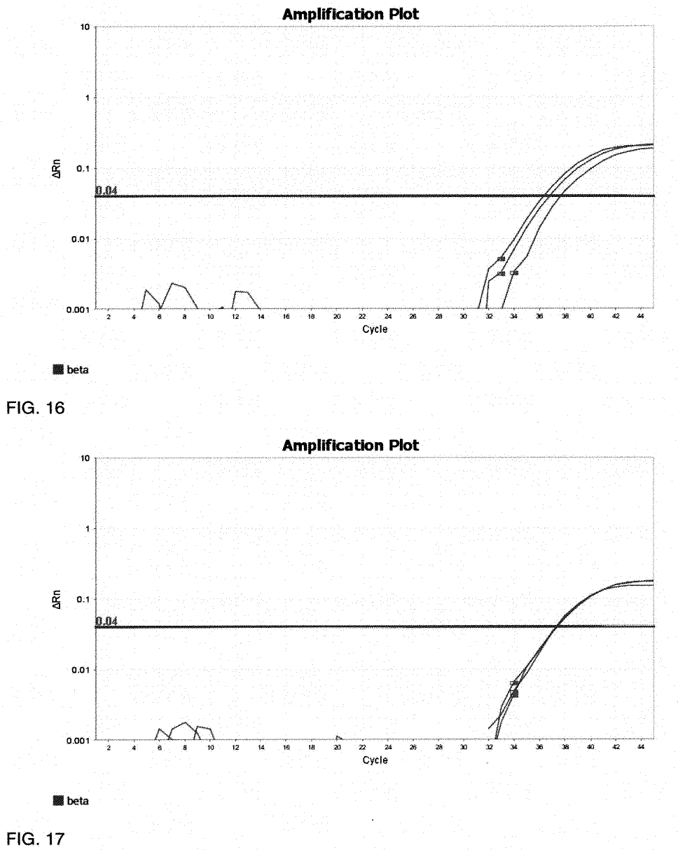

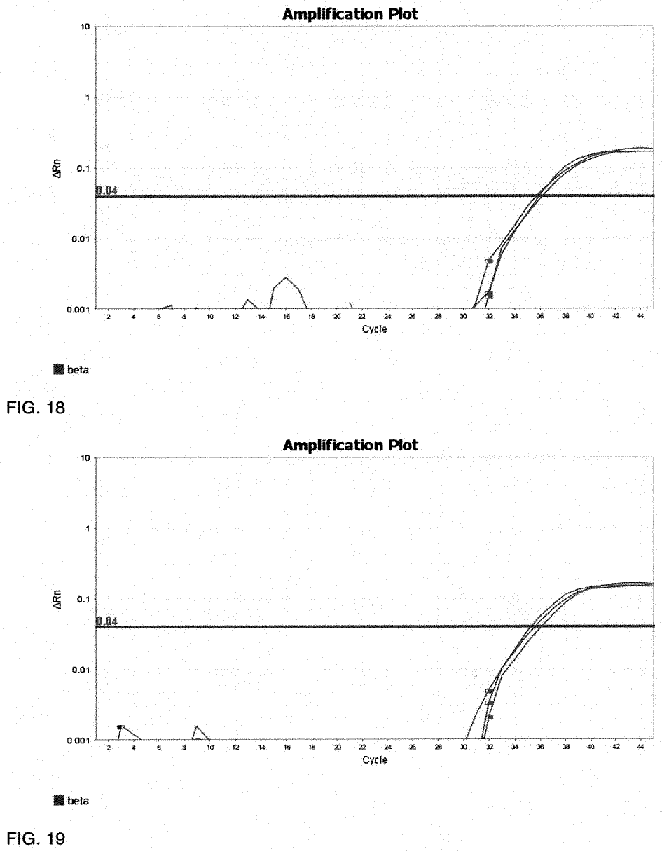

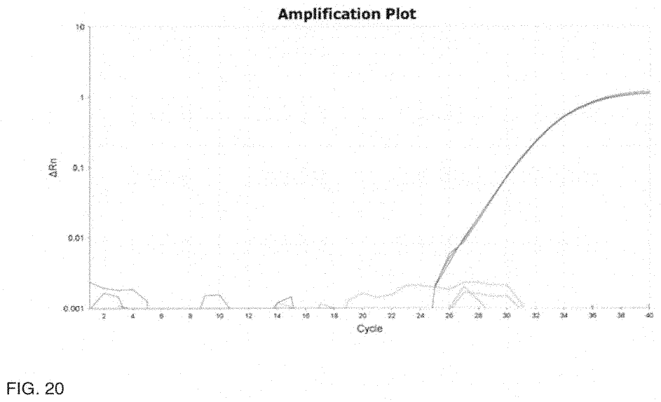

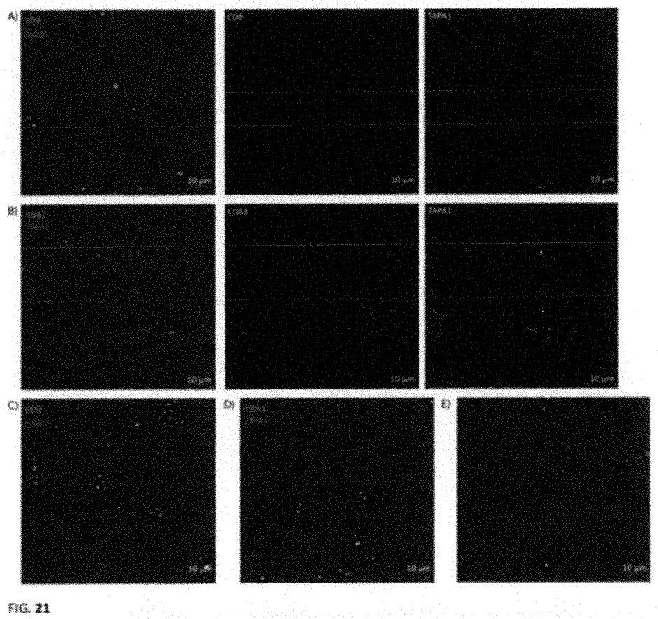

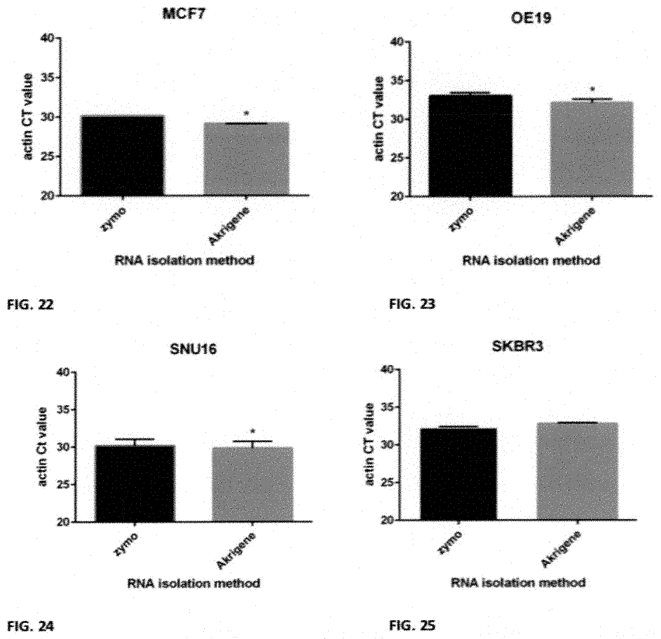

The invention is illustrated in a preferred embodiment, in the form of a device in which biological samples may be collected as illustrated in FIGS. 1-14.

The filtration-collection system includes a conduit with an internal switch (10) in the main chamber (20) with two ports on either end (30, 40). (40) and (30) act as both inlet and outlet ports. The collection chamber (70) extends perpendicular from the main chamber of the conduit with an inlet/outlet port (80) located at the posterior end (FIG. 1).

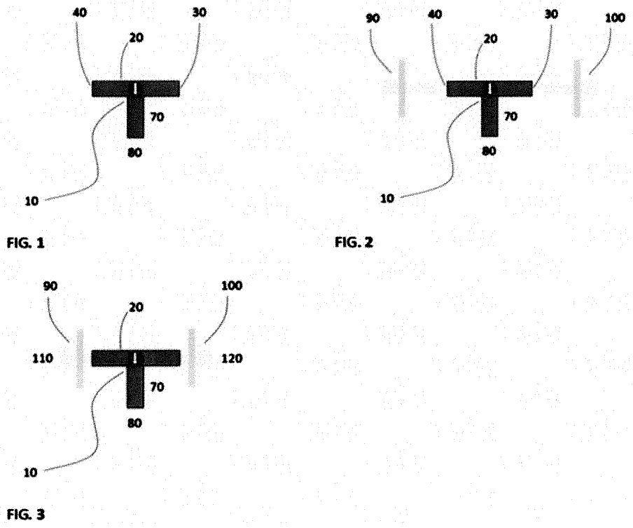

A compatible syringe filter (90) is inserted into port (40) and acts as the primary filter for the device. Another compatible syringe filter (100) is inserted into port (30) and acts as the secondary filter for the device (FIG. 2). Alternatively, the primary filter and secondary filter are integrated into the conduit unit.

A compatible device, e.g. a syringe, containing a biological sample, where volume can range from 1-10 milliliter, is attached to the primary filter (90) port inserted or integrated into port (40) of the conduit. A piston applies pressure, e.g. the user presses down on the plunger of the syringe, to dispense biological fluid into, first, the primary filter, and once saturated, the interior of the main chamber (20) of the conduit. In this instance, the switch (10) is in position 1 to allow filtrate to flow to the outlet port (30) and into the secondary filter. The switch in position 1 prevents the biological fluid from entering the collection chamber (70). The biological fluid saturates the secondary filter and exits the filter port (120). (FIGS. 7,8,9) Preferably the device is held in a manner such that the sample can be collected by allowing the sample to drip into a collection tube by gravity.

Once dispensing of the biological sample is complete, and in order to ensure complete filtration of the entire sample, the device containing the biological sample is removed from the primary filter port and another device containing the wash solution is attached. A piston applies pressure, for example, the user presses down on the plunger of the syringe, to dispense wash solution into the primary filter and the interior of the main chamber (20) of the conduit. In this instance, the switch (10) is in position 1 to allow the solution to flow to into the secondary filter outlet port (120). The switch in position 1 prevents the wash solution from entering the collection chamber (70). The wash solution enters the secondary filter and exits the filter. The filtrate can be collected with a collection tube.

A new device, e.g. a syringe, containing a volume ranging from 50 ul to 1 ml of eluent solution, is attached to the secondary filter port. A piston applies pressure, e.g. the user presses down on the plunger of the syringe, to dispense the eluent solution into the secondary filter and the interior of the main chamber (20) of the conduit. In this instance, the switch (10) is in position 2 to allow the solution to flow into the collection chamber (70) and into the outlet port (80). The switch in position 2 prevents the eluent solution from entering the primary filter section of the main chamber (40). Preferably the device is held in a manner such that the sample can be collected by allowing the sample to drip into the collection tube by gravity. (FIGS. 10,11,12)

Similarly, a new device, e.g. a syringe, containing a volume ranging from 50 ul to 1 ml of eluent solution, is attached to the collection chamber port. A piston applies pressure, e.g. the user presses down on the plunger of the syringe, to dispense the eluent solution into the collection chamber port (80) and the interior of the main chamber (20) of the conduit. In this instance, the switch (10) is in position 3 to allow the solution to flow from the collection chamber (70) into the primary filter outlet port (110). The switch in position 3 prevents the eluent solution from entering the secondary filter section of the main chamber (30). Preferably the device is held in a manner such that the sample can be collected by allowing the sample to drip into the collection tube by gravity. (FIGS. 13,14)

What is claimed is:

1) An apparatus and method that can utilize entire biological samples by separating intact particles into multi-tiered filtrates without the need for multiple re-draws of sample or filtrate for use in downstream biological procedures comprising of the components and steps of:
i) a primary filter, typically equal to or larger than 0.22 microns, to trap and collect particles equal to or larger than the filter pore size used;
ii) a secondary filter, typically a smaller pore size than the primary filter, typically smaller than 0.22 microns, to trap particles equal to or larger than the filter pore size used;
iii) a main conduit, containing the primary and secondary filters, a switch and a collection chamber extending perpendicular to the main chamber, that allows the biological samples to transition from inlet port to desired outlet port via switch position;
iv) an inlet/outlet port to collect small particles, or particles smaller in size than the secondary filter pore size, e.g. less than 0.05 microns, from the biological sample, also used as an elution port to elute intermediate particles;
v) an inlet/outlet port on the collection chamber to allow intermediate size filtrate, or particles ranging in size from the primary filter pore size to the secondary filter pore size, e.g. 0.22 microns to 0.05 microns, to be collected, or to attach additional devices to the apparatus such as extended tubing, pumps, peltier device, ultrasonication, acoustic vibration, or microfluidic devices, also used as an inlet port to elute large particles;
vi) an inlet/outlet port to collect large size range particles, or particles larger in size than the primary filter pore size, e.g. greater than 0.22 microns, from the biological sample, also used as an injection port to process the biological sample.
b) In one aspect of claim 1, the filters are of fixed size and integrated into the conduit. In some embodiments, the device is customizable with off the shelf syringe filters, e.g., Millex® (Merck Millipore, Cork, Ireland). In another embodiment, there is some combination of fixed and customized filter sizes and filter types.
c) In one embodiment of claim 1 i), the primary filter type is PES. In another it is PVDF. Or any other suitable material. In one embodiment, the primary casing size is 33 mm. In another it is 13 mm, or integrated into the conduit, or any other size. In one embodiment, the primary membrane size is 0.22 microns. In another it is 0.45 microns, 1 micron or any other size.
d) In one embodiment of claim 1 ii), the secondary filter type is PES. In another it is PVDF. Or any other suitable material. In one embodiment, the secondary filter casing size is 33 mm. In another it is 13 mm, or integrated into the conduit, or any other size. In one embodiment, the secondary filter membrane size is 0.03 microns. In another it is 0.05 microns, 0.045 microns or any other size.

2) The present invention features methods of separating a biological sample into multiple tiered filtrate components. In some embodiments, the biological sample comprises biological fluid, e.g. human biological fluid. In one embodiment, the sample comprises urine, mucus, saliva, tears, blood, serum, plasma, sputum, cerebrospinal fluid, ascites fluid, semen, lymph fluid, airway fluid, intestinal fluid, breast milk, amniotic fluid or any combination thereof.
i) In one embodiment of claim 2, the wash solution consists of 1×PBS pH 7.4. In another embodiment the wash solution consists of 1×PBS pH 7.5 with 0.05% polysorbate 20, or molecular grade water, or Tris-EDTA pH 8.0, or TE pH 7.4 or some combination of two or all.
ii) In one embodiment of claim 2, the eluting solution consists of 1×PBS pH 7.4. In another embodiment the eluting solution consists of 1×PBS pH 7.5 with 0.05% polysorbate 20, or molecular grade water, or Tris-EDTA pH 8.0, or TE pH 7.4 or some combination of two or all.
iii) In one embodiment of claim 2, the flow of biological fluid is controlled by either an electrically or manually driven piston. Pressure applied to either of the main chamber inlet ports or the collection chamber inlet port, with the switch in position 1, 2, or 3, determines the direction of fluid flow. When fluid is dispensed into the primary filter with the switch in position 1, it enters the main chamber and exits the secondary filter outlet port. When fluid is dispensed into the secondary filter with the switch in the position 2, it enters the main chamber and is re-directed into the collection chamber outlet port. When fluid is dispensed into the collection chamber inlet port with the switch in position 3, it enters the main chamber and is re-directed to the primary filter outlet port.
iv) In one embodiment of claim 2, the piston is part of an electrical pump. In another embodiment, the piston is manually driven and is part of a syringe or some other device.

3) Filtrates, once collected, can be used for downstream applications such as PCR, RT-PCR, NGS and protein analysis. Nucleic acids are protected from degradation inside vesicle lipid bilayers so filtrates can be stored several months at −80° C. without effecting downstream results. Extracellular vesicle lipid bilayers are disrupted using high heat to facilitate the release of nucleic acids and other cargo. For example, a 25 μL aliquot of the filtrate can be heated at 95° C. for 10 min to release RNA. A one step RT-PCR kit (Bioline, Cat #78001) is then used to create cDNA using either random hexamer primers, polyT primers or gene specific primers or some combination. The PCR amplification step is carried out in the same well where an amplicon specific fluorescent probe allows the target to be quantified through an amplification dependent increase in fluorescence. The use of different fluorescent dyes permits multiple targets to be analyzed in a single reaction.

4) Nucleic acid released from vesicles can be modified for use in various sequencing applications. Adaptors and priming sites can be added to cDNA and DNA for sequencing via Illumina sequencers, such as the Illumina miniSeq or Oxford Nanopore Technologies Minlon.
